(19) United States
(12) Patent Application Publication
(10) Pub. No.: US 2013/0218439 A1
(43) Pub. Date: Aug. 22, 2013

(54) CONTROLLING VARIABLE VALVE ACTUATION SYSTEM

(71) Applicants: Raj Lumar, Elk Grove Village, IL (US); William De Ojeda, Oak Park, IL (US); James Rynold Popp, Oak Creek, WI (US); Daniel Cornelius, Chicago, IL (US)

(72) Inventors: Raj Lumar, Elk Grove Village, IL (US); William De Ojeda, Oak Park, IL (US); James Rynold Popp, Oak Creek, WI (US); Daniel Cornelius, Chicago, IL (US)

(73) Assignee: INTERNATIONAL ENGINE INTELLECTUAL PROPERTY COMPANY, LLC, Lisle, IL (US)

(21) Appl. No.: 13/882,347

(22) PCT Filed: Oct. 28, 2010
(86) PCT No.: PCT/US10/54438

§ 371 Date: Apr. 29, 2013

(51) Int. Cl. B60W 10/06

(52) U.S. Cl. CPC B60W 10/06
USPC 701/102

(57) ABSTRACT

A method of controlling a variable valve actuation system for an internal combustion engine having a plurality of cylinders, each of the plurality of cylinders having a variable valve actuator and in-cylinder pressure sensor is provided. Output of an in-cylinder pressure sensor is monitored at a predetermined crank angle Θp with an electronic control module. The output of the in-cylinder pressure sensor of the monitored one of the plurality of cylinders at the predetermined crank angle Θp is compared to a stored threshold value for in-cylinder pressure at the predetermined crank angle. A variable valve actuator is adjusted to adjust a crank angle Θc corresponding to when an intake valve of the monitored one of the plurality of cylinders closes when the output of the in-cylinder pressure sensor of the monitored one of the plurality of cylinders does not correspond to the stored threshold value.

### TECHNICAL FIELD

The present disclosure relates to control of intake air flow used for combustion in an internal combustion engine, and more particularly to a system and method for controlling intake air flow used for combustion in an internal combustion engine using variable valve actuation on an internal combustion engine having in-cylinder pressure sensors.

### BACKGROUND

Many factors, including environmental responsibility efforts and modern environmental regulations on engine exhaust emissions, have reduced the allowable acceptable levels of certain pollutants that enter the atmosphere following the combustion of fossil fuels. Increasingly, more stringent emission standards may require greater control over either or both the combustion of fuel and post combustion treatment of the exhaust. For example, the allowable levels of nitrogen oxides (NOx) and particulate matter have been greatly reduced over the last several years. Fuel injection timing and a quantity of fuel to be injected has been found to be an important factor in emission formation, along with other aspects such as exhaust gas recirculation (EGR), vane settings of variable geometry turbochargers (VGTs), intake manifold temperature, and intake valve timing.

One approach to control fuel injection timing has utilized an in-cylinder pressure sensor in order to more accurately control the crank angle where a certain percentage of fuel injected into the cylinder had combusted, such that the crank angle past top dead center (TDC) where 50% of the fuel injected into a cylinder had combusted was generally identical between cylinders in an engine having a plurality of cylinders. Similarly, phasing of the fuel injection into each cylinder may be monitored and controlled such that the crank angle at start of fuel injection into any one cylinder does not differ beyond a threshold amount from an average crank angle for start of fuel injection. Precise control of fuel injection can be utilized to regulate combustion in a manner that reduces engine emissions and improves fuel consumption. However, while controlling fuel injection is useful from an emissions and fuel consumption perspective, control of intake air flow into cylinders of an engine is also important in controlling engine emissions and fuel consumption.

Variable valve actuation is known to be used to control an amount of intake air, typically a mixture of intake air and recirculated engine exhaust, used for combustion. Differences in an amount of intake air fed to each cylinder may result in cylinder-to-cylinder differences in torque output, higher emissions, and increased fuel consumption. Previous attempts to utilize variable valve actuation have not been able to precisely control air flow into each cylinder. Therefore, a need exists for a method and system to control a variable valve actuation system to balance air flow into each cylinder of an internal combustion engine.

### SUMMARY

According to one process, a method of controlling a variable valve actuation system for an internal combustion engine having a plurality of cylinders, each of the plurality of cylinders has a variable valve actuator and in-cylinder pressure sensor is provided. Output of an in-cylinder pressure sensor, wherein the in-cylinder pressure sensor is in operable communication with one of a plurality of cylinders, is monitored at a predetermined crank angle Θₚ with an electronic control module. The output of the in-cylinder pressure sensor of the monitored one of the plurality of cylinders at the predetermined crank angle Θₚ is compared to a stored threshold value for in-cylinder pressure at the predetermined crank angle. A variable valve actuator is adjusted to adjust a crank angle Θ_{c} corresponding to when an intake valve of the monitored one of the plurality of cylinders closes when the output of the in-cylinder pressure sensor of the monitored one of the plurality of cylinders does not correspond to the stored threshold value.

According to another process, a method of controlling a variable valve actuation system for an internal combustion engine having a plurality of cylinders, each of the plurality of cylinders has a variable valve actuator and in-cylinder pressure sensor, is provided. Output of an in-cylinder pressure sensor of a plurality of cylinders at a predetermined crank angle Θₚ is monitored with an electronic control module. A pressure setpoint value of the plurality of cylinders at a predetermined crank angle Θₚ is generated. The output of each of the plurality of in-cylinder pressure sensors at the predetermined crank angle Θₚ is compared to the pressure setpoint value. A revised valve closing crank angle Θ_{c} is generated for each of the plurality of cylinders. A variable valve actuator is adjusted to adjust the valve closing crank angle Θ_{c} for each of the plurality of cylinders to the revised valve closing crank angle Θ_{c}.

According to one embodiment, a physical computer program product, comprises a computer usable medium that has an executable computer readable program code embodied therein. The executable computer readable program code implements a method of controlling a variable valve actuation system for an internal combustion engine has a plurality of cylinders, each of the plurality of cylinders having a variable valve actuator and in-cylinder pressure sensor is provided. Output of an in-cylinder pressure sensor, wherein the in-cylinder pressure sensor is in operable communication with one of a plurality of cylinders, is monitored at a predetermined crank angle Θₚ with an electronic control module. The output of the in-cylinder pressure sensor of the monitored one of the plurality of cylinders at the predetermined crank angle Θₚ is compared to a stored threshold value for in-cylinder pressure at the predetermined crank angle. A variable valve actuator is adjusted to adjust a crank angle Θ_{c} corresponding to when an intake valve of the monitored one of the plurality of cylinders closes when the output of the in-cylinder pressure sensor of the monitored one of the plurality of cylinders does not correspond to the stored threshold value.

### BRIEF DESCRIPTION OF THE DRAWINGS

FIG. 1 is a schematic diagram showing an engine having a plurality of cylinders with in-cylinder pressure sensors and a variable valve actuation system.

FIG. 2 is a sectional view of an engine showing a cylinder having an in-cylinder pressure sensor.

FIG. 3 is a block diagram showing a first portion of a control system for a variable valve actuation system.

FIG. 4 is a block diagram showing second portion of a control system for a variable valve actuation system.

FIGS. 5a and 5b are graphs showing the affect of using the variable valve actuation system of the present disclosure on cylinder pressure and heat release.

FIG. 6 is a graph showing the affect of using the variable valve actuation system of the present disclosure on visible smoke formation and fuel consumption.

FIG. 7 is a graph showing the affect of using the variable valve actuation system of the present disclosure on start of fuel injection.

### DETAILED DESCRIPTION

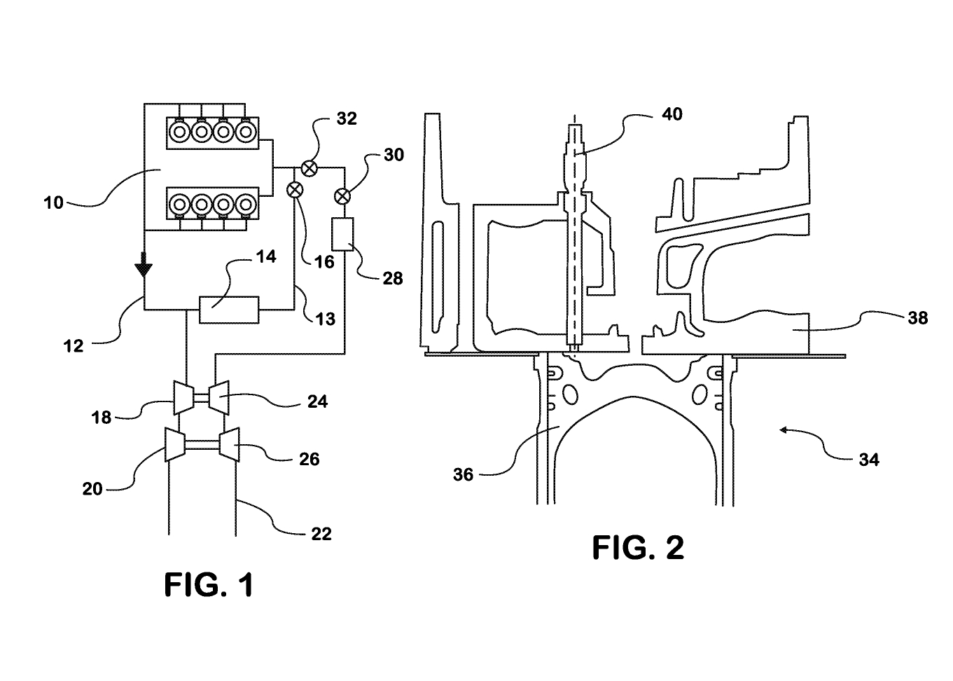

FIG. 1 shows an engine 10 having an exhaust system 12. The exhaust system 12 has an exhaust gas recirculation (“EGR”) portion 13. The EGR portion 13 has an EGR cooler 14 and an EGR valve 16. The EGR cooler 14 reduces the temperature of exhaust gas within the EGR portion 13. The exhaust system 12 additionally is shown as having a first turbocharger turbine 18 and a second turbocharger turbine 20. The EGR valve 16 controls the flow of exhaust gas within the EGR portion 13.

The engine 10 additionally has an air intake system 22. The air intake system 22 has a first turbocharger compressor 24 and a second turbocharger compressor 26. A charge air cooler 28 is additionally provided to cool intake air within the air intake system 22. A first throttle valve 30 and a second throttle valve 32 are also disposed within the air intake system 22. The first turbocharger turbine 18 and the first turbocharger compressor 24 form a first turbocharger and the second turbocharger turbine 20 and the second turbocharger compressor 26 form a second turbocharger. It is contemplated that the first turbocharger and the second turbocharger may be variable geometry turbochargers.

Turning now to FIG. 2, a cross section of a cylinder 34 of the engine 10. The cylinder 34 has a piston 36 that moves reciprocally within the cylinder 34. A cylinder head 38 is disposed above the cylinder 34, such that the movement of the piston 36 within the cylinder 34 increases a pressure within the cylinder 34. An in-cylinder pressure sensor 40 is additionally provided. The in-cylinder pressure sensor 40 is disposed within the cylinder head 38 and a portion of the in-cylinder pressure sensor 40 is exposed within the cylinder 34. The in-cylinder pressure sensor 40 monitors the pressure within the cylinder 34. In a multi-cylinder engine 10, there are multiple sensors 40 forming a sensor group 41.

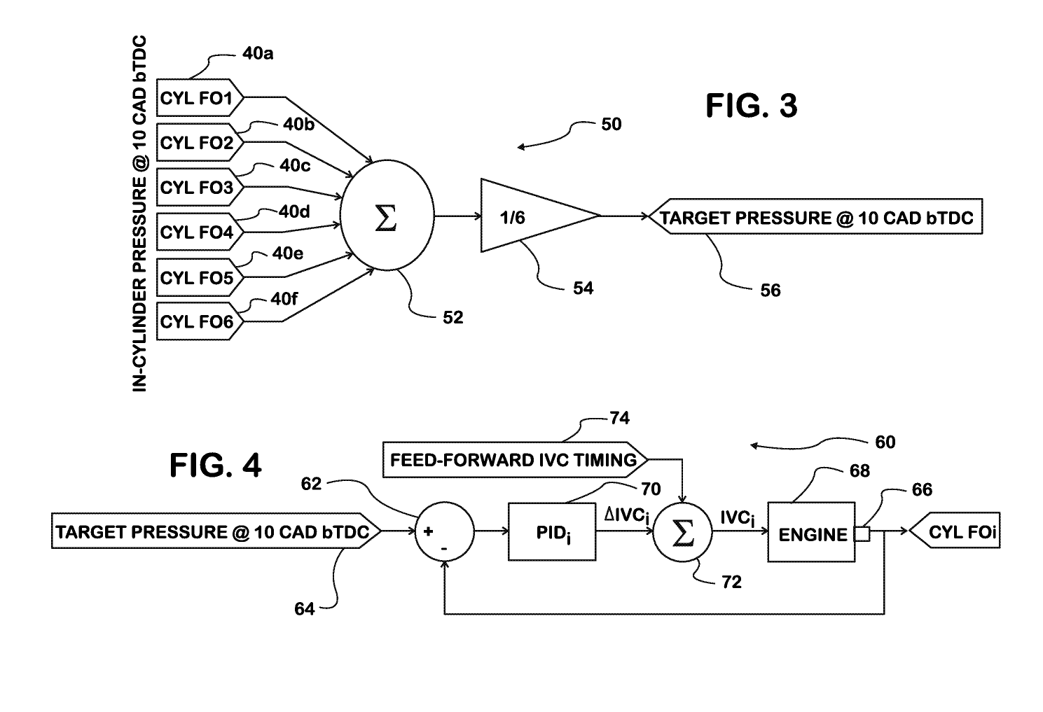

FIG. 3 shows a block diagram 50 that depicts how an average in-cylinder pressure at a predetermined crank angle before piston top dead center (TDC) is determined for an engine with a plurality of cylinders. Output of in-cylinder pressure sensors 40a-40f are communicated to a summation device 52. It is contemplated that the summation device 52 is part of an electronic control module (ECM). The summation device 52 adds the output of the in-cylinder pressure sensors 40a-40f. Output of the summation device 52 is transmitted to an averaging unit 54. The averaging unit 54 divides the output of the summation device 52 by the total number of cylinders of the engine. For example, if an engine has six cylinders, the averaging unit 54 divides the output of the summation device 52 by six. The averaging unit 54 generates an output that is used in some embodiments as a threshold value 56, or setpoint value, for in-cylinder pressure at a predetermined crank angle to control variable valve actuators on intake valves of the engine. As shown in FIG. 3, the predetermined crank angle is ten degrees before top dead center (TDC). However, it is contemplated that the predetermined crank angle can be other crank angles in a range from about twenty degrees before TDC to about five degree before TDC. The predetermined crank angle is selected such that combustion is not contributing to the pressure within the cylinder.

Turning now to FIG. 4, a block diagram 60 of the control of a variable valve actuator is shown. It is contemplated that the block diagram 60 occurs within the ECM of the engine. A comparator 62 receives an input of a threshold value 64 for in-cylinder pressure at a predetermined crank angle as well as an input of an actual in-cylinder pressure 66 from an engine 68 at the predetermined crank angle. The comparator 62 determines a difference between the actual in-cylinder pressure 66 and the threshold value 64. The comparator 62 outputs the difference to a processor 70.

The processor 70 generates an adjustment for a variable valve actuator that adjusts a crank angle when an intake valve for a cylinder will close. For example, if the comparator 62 shows that the actual in-cylinder pressure within a particular cylinder is lower than the threshold value, the variable valve actuator will be controlled to close the valve earlier, i.e., at a crank angle that is a greater number of degrees before TDC than the previous crank angle when the intake valve closed. Conversely, if the comparator 62 shows that the actual in-cylinder pressure within a particular cylinder is higher than the threshold value, the variable valve actuator will be controlled to close the valve later, i.e., at a crank angle that is a lesser number of degrees before TDC than the previous crank angle when the intake valve closed.

A summation unit 72 receives the adjustment value for the variable valve actuator from the processor 70, and also receives the previous variable valve actuator setting 74. The summation unit adjusts the previous variable valve actuator setting 74 by the adjustment value, and transmits an adjusted variable valve actuator setting to the engine 68.

Utilizing the in-cylinder pressure based control of the variable valve actuators for each of the cylinders of the engine, volumetric inefficiencies from cylinder-to-cylinder in an engine having a plurality of cylinder may be reduced. The reduction of these volumetric inefficiencies also reduces imbalances of heat transfer, piston-ring leakage, and uneven compression within cylinders.

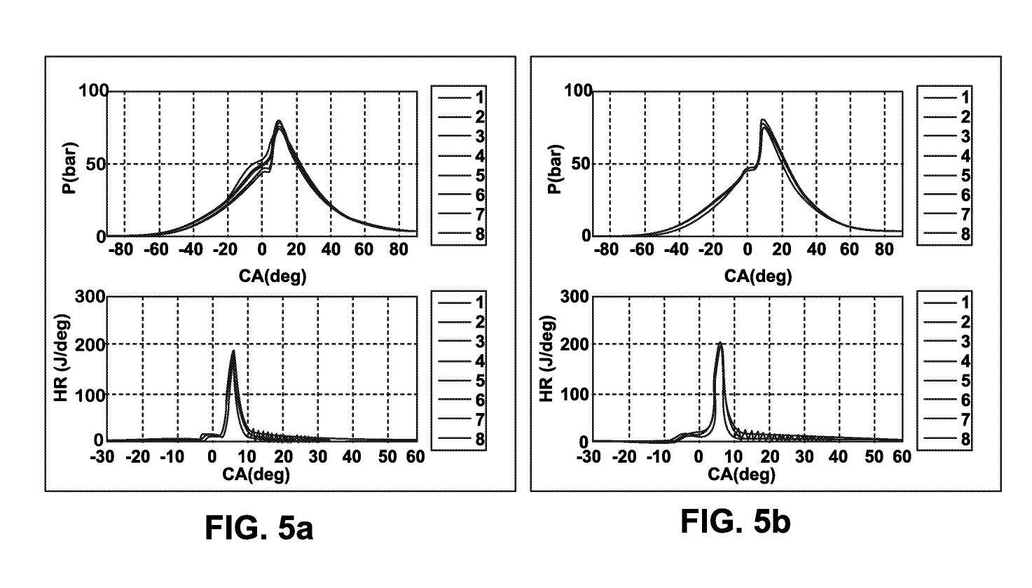

FIG. 5a shows a graph of in-cylinder pressures for an engine with eight cylinders as well as a heat release graph for the engine with eight cylinders. The engine of FIG. 5a does not feature in-cylinder pressure controlled variable valve actuators, and thus, as can be observed, noticeable differences exist in the pressure within the various cylinders at the same crank angles. Similarly, the heat release rate of the plurality of cylinders also varies.

FIG. 5b shows a similar graph as shown in FIG. 5a, but the engine of FIG. 5b features in-cylinder pressure sensor controlled variable valve actuators. As can be seen, the pressure within each of the cylinders of FIG. 5b is more uniform than that shown in FIG. 5a. Similarly, the heat release rate of the engine having in-cylinder pressure sensor controlled variable valve actuators is more uniform, as seen in FIG. 5b, than in an engine without such features, as shown in FIG. 5a.

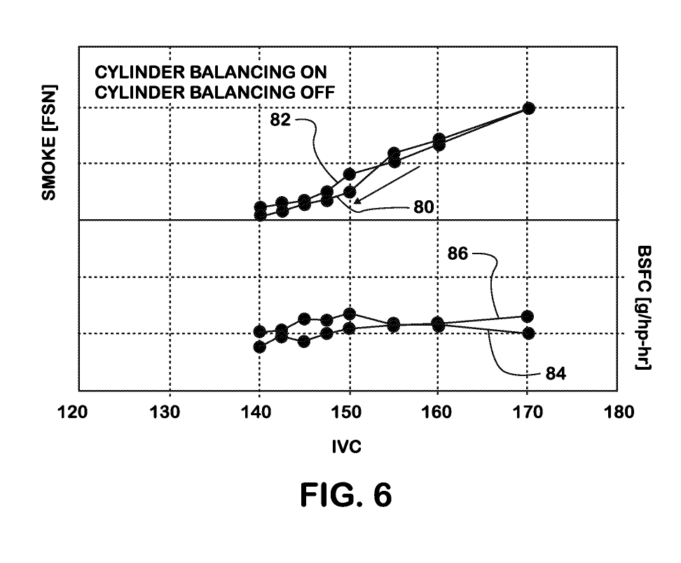

Turning now to FIG. 6, a first line 80 shows production of particulate matter, or smoke, by an engine having in-cylinder pressure sensor controlled variable valve actuators, while a second line 82 shows production of particulate matter, or smoke, by an engine without in-cylinder pressure sensor controlled variable valve actuators. Both the first line 80 and the second line 82 show the amount of particulate matter at various valve closing crank angles. When in-cylinder pressure sensor controlled variable valve actuators are present, the amount of particulate matter produced is generally reduced, especially at earlier intake valve closing crank angles.

Similarly, FIG. 6 also shows a third line 84 that shows break specific fuel consumption for an engine with in-cylinder pressure sensor controlled variable valve actuators, while a fourth line 86 shows brake specific fuel consumption for an engine without in-cylinder pressure sensor controlled variable valve actuators. When in-cylinder pressure sensor controlled variable valve actuators are utilized, the fuel consumption is typically reduced, as the third line 84 is typically below the fourth line 86.

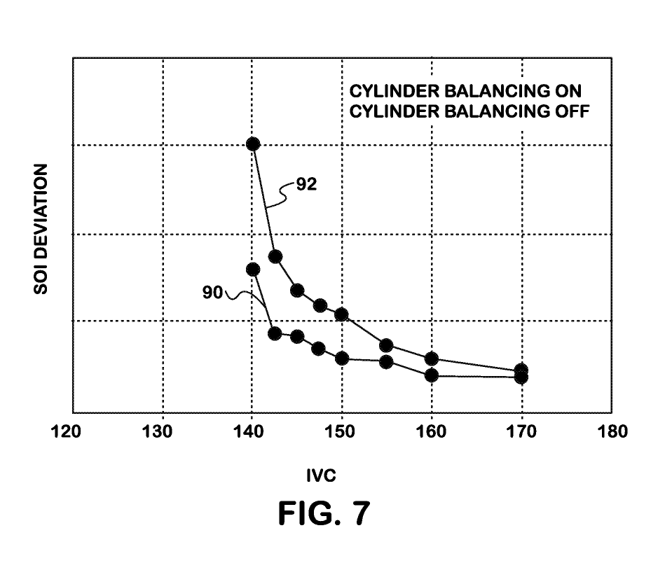

In addition to reducing emissions output and fuel consumption, an engine with in-cylinder pressure sensor controlled variable valve actuators also achieve greater stability in start of fuel injection for the plurality of cylinders. FIG. 7 shows a first line 90 graphing a standard deviation of start of injection timing for an engine with in-cylinder pressure sensor controlled variable valve actuators, while a second line 92 graphs a standard deviation of start of injection timing for an engine with in-cylinder pressure sensor controlled variable valve actuators. The first line 90 is always less than the second line 92, thus, the use of in-cylinder pressure sensor controlled variable valve actuators reduces the variation in start of injection timing between the cylinders. This increased stability reduces the chances of the engine misfiring, which can also produce additional emissions output and increase fuel consumption.

It will be understood that a control system may be implemented in hardware to effectuate the method. The control system can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

When the control system is implemented in software, it should be noted that the control system can be stored on any computer readable medium for use by or in connection with any computer related system or method. In the context of this document, a “computer-readable medium” can be any medium that can store, communicate, propagate, or transport the program for use by or in connection with the instruction execution system, apparatus, or device. The computer readable medium can be, for example, but is not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical) and a portable compact disc read-only memory (CDROM) (optical). The control system can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

What is claimed is:

1. A method of controlling a variable valve actuation system for an internal combustion engine having a plurality of cylinders, each of the plurality of cylinders having a variable valve actuator and in-cylinder pressure sensor, the method comprising:
monitoring output of an in-cylinder pressure sensor, wherein the in-cylinder pressure sensor is in operable communication with one of a plurality of cylinders, at a predetermined crank angle Θₚ with an electronic control module;
comparing the output of the in-cylinder pressure sensor of the monitored one of the plurality of cylinders at the predetermined crank angle Θₚ to a stored threshold value for in-cylinder pressure at the predetermined crank angle; and
adjusting a variable valve actuator to adjust a crank angle Θ_{c} corresponding to when an intake valve of the monitored one of the plurality of cylinders closes when the output of the in-cylinder pressure sensor of the monitored one of the plurality of cylinders does not correspond to the stored threshold value.

2. The method of claim 1, wherein the predetermined crank angle Θₚ is from about twenty degrees before top dead center to about five degrees before top dead center.

3. The method of claim 2, wherein the predetermined crank angle Θₚ is about ten degrees before top dead center.

4. The method of claim 1, wherein the threshold value for in-cylinder pressure is based upon an average pressure of the plurality of cylinders at the predetermined crank angle Θₚ.

5. The method of claim 4, wherein the threshold value for in-cylinder pressure is an average pressure of the plurality of cylinders at the predetermined crank angle Θₚ.

6. The method of claim 1, wherein the adjustment of the variable valve actuator closes the intake valve at an earlier crank angle Θ_{c2} before top dead center than the previous crank angle Θ_{c1} when the intake valve closed when the output of the in-cylinder pressure sensor of the first cylinder is less than the stored threshold value.

7. The method of claim 1, wherein the adjustment of the variable valve actuator closes the intake valve at a later crank angle Θ_{c2} before top dead center than the previous crank angle Θ_{c1} when the intake valve closed when the output of the in-cylinder pressure sensor of the first cylinder is more than the stored threshold value.

8. The method of claim 1, wherein the adjustment of the variable valve actuator is based upon a lookup table having adjustments based upon an amount of difference between the output of the in-cylinder pressure sensor of the first cylinder at the predetermined crank angle and the stored threshold value.

9. A method of controlling a variable valve actuation system for an internal combustion engine having a plurality of cylinders, each of the plurality of cylinders having a variable valve actuator and in-cylinder pressure sensor, the method comprising:
monitoring output of an in-cylinder pressure sensor of a plurality of cylinders at a predetermined crank angle Θₚ with an electronic control module;
generating a pressure setpoint value of the plurality of cylinders at a predetermined crank angle Θₚ;
comparing the output of each of the plurality of in-cylinder pressure sensors at the predetermined crank angle Θₚ to the pressure setpoint value;
calculating a revised valve closing crank angle Θ_{c} for each of the plurality of cylinders; and
adjusting a variable valve actuator to adjust the valve closing crank angle Θ_{c} for each of the plurality of cylinders to the revised valve closing crank angle.

10. The method of claim 9, wherein the predetermined crank angle Θₚ is from about twenty degrees before top dead center to about five degrees before top dead center.

11. The method of claim 10, wherein the predetermined crank angle Θₚ is about ten degrees before top dead center.

12. The method of claim 9, wherein the adjustment of the variable valve actuator closes the intake valve at an earlier crank angle Θ_{c2} before top dead center than the previous crank angle Θ_{c1} when the intake valve closed when the output of the in-cylinder pressure sensor of the first cylinder is less than the stored threshold value.

13. The method of claim 9, wherein the adjustment of the variable valve actuator closes the intake valve at a later crank angle Θ_{c2} before top dead center than the previous crank angle Θ_{c1} when the intake valve closed when the output of the in-cylinder pressure sensor of the first cylinder is more than the stored threshold value.

14. The method of claim 9, wherein the adjustment of the variable valve actuator is based upon a lookup table having adjustments based upon an amount of difference between the output of the in-cylinder pressure sensor of the first cylinder at the predetermined crank angle Θₚ and the pressure setpoint value.

15. A physical computer program product, comprising a computer usable medium having an executable computer readable program code embodied therein, the executable computer readable program code for implementing a method of controlling a variable valve actuation system for an internal combustion engine having a plurality of cylinders, each of the plurality of cylinders having a variable valve actuator and in-cylinder pressure sensor, the method comprising:
monitoring output of an in-cylinder pressure sensor, wherein the in-cylinder pressure sensor is in operable communication with one of a plurality of cylinders, at a predetermined crank angle Θₚ with an electronic control module;
comparing the output of the in-cylinder pressure sensor of the monitored one of the plurality of cylinders at the predetermined crank angle Θₚ to a stored threshold value for in-cylinder pressure at the predetermined crank angle; and
adjusting a variable valve actuator to adjust a crank angle Θ_{c} corresponding to when an intake valve of the monitored one of the plurality of cylinders closes when the output of the in-cylinder pressure sensor of the monitored one of the plurality of cylinders does not correspond to the stored threshold value.

16. The method of claim 15, wherein the predetermined crank angle Θₚ is from about twenty degrees before top dead center to about five degrees before top dead center.

17. The method of claim 16, wherein the predetermined crank angle Θₚ is about ten degrees before top dead center.

18. The method of claim 15, wherein the threshold value for in-cylinder pressure is based upon an average pressure of the plurality of cylinders at the predetermined crank angle.

19. The method of claim 15, wherein the adjustment of the variable valve actuator closes the intake valve at an earlier crank angle Θ_{c2} before top dead center than the previous crank angle Θ_{c1} when the intake valve closed when the output of the in-cylinder pressure sensor of the first cylinder is more than the stored threshold value.

20. The method of claim 15, wherein the adjustment of the variable valve actuator closes the intake valve at a later crank angle Θ_{c2} before top dead center than the previous crank angle Θ_{c1} when the intake valve closed when the output of the in-cylinder pressure sensor of the first cylinder is more than the stored threshold value.
